(19) United States
(12) Patent Application Publication
(10) Pub. No.: US 2005/0128743 A1
(43) Pub. Date: Jun. 16, 2005

(54) Light apparatus and method for controlling the intensity of a light emitting diode

(75) Inventors: Mark D. Chuey, Northville, MI (US); Stephen Chung, Taipei (TW); Mordechai Lev, West Bloomfield, MI (US); Roman S. Ferber, West Bloomfield, MI (US)

Correspondence Address: BROOKS KUSHMAN P.C., 1000 TOWN CENTER, TWENTY-SECOND FLOOR, SOUTHFIELD, MI, 48075, US

(73) Assignee: HoMedics, Inc., Commerce Township, MI (US)

(21) Appl. No.: 10/955,788

(22) Filed: Sep. 30, 2004

Related U.S. Application Data
(60) Provisional application No. 60/529,777, filed on Dec. 16, 2003.

(51) Int. Cl. F21V 33/00; F21V 1/00

(52) U.S. Cl. 362/234

(57) ABSTRACT

A light apparatus is provided having a housing and an array of light emitting units integrally formed within the housing, each light emitting unit containing at least one light emitting diode (LED). The apparatus further includes a processor in communication with the LEDs in each light emitting unit, and user input controls in communication with the processor for controlling the light emitting units, such that a light color displayed by each light emitting unit can vary with time. Methods for controlling the intensity of an LED are also provided.

### CROSS-REFERENCE TO RELATED APPLICATIONS

This application claims the benefit of U.S. provisional application Ser. No. 60/529,777 filed Dec. 16, 2003.

### BACKGROUND OF THE INVENTION

1. Field of the Invention

The present invention relates to a light apparatus and method for providing a light display using LEDs.

2. Background Art

Combining light of one color with light of another color will result in the creation of a third color. For example, red, blue, and green lights can be combined in different proportions or intensities to create almost any color in the visible spectrum. Light emitting diodes (LEDs) of different colors may be used for this purpose. It would be desirable to apply LED lighting technology to an application useful for home sensory therapy. It would further be desirable to have an affordable lighting device based on LED technology that creates a relaxing, stimulating, and entertaining light show for a user.

One conventional approach utilizing LEDs powers each of three color LEDs through a transistor biasing scheme, in which a base of a transistor is connected to a respective latch register through biasing resistors. Typically, three latches are all simultaneously connected to the same data lines on a data bus. As such, it is not possible to control all LED transistor biases independently and simultaneously. Biasing of transistors using this approach is inefficient because the power delivered to the LEDs is less than the power dissipated in the biasing network. Therefore, this approach is not well suited to illumination applications requiring any degree of efficiency.

In another conventional approach, a pulse width modulated signal is used to provide current to a plurality of LEDs. The pulse width modulation is controlled to create a particular duty cycle. However, most approaches that employ this method make no provision for precise and rapid control over the spectrum of colors emitted.

It would be desirable to have a system and method to control the intensity of LEDs that allows for nearly any color in the color spectrum to be emitted at any desired point in time. It would also be desirable to have a high performance, microcontroller-based control for a multi-color LED lighting system that is efficient, highly adaptable to present microcontroller and microprocessor architectures, inexpensive to manufacture, and lends itself to a greater number of physical implementations than pulse width modulation.

### SUMMARY OF THE INVENTION

Accordingly, a light apparatus is provided having a housing, and an array of light emitting units integrally formed within the housing, each light emitting unit containing at least one light emitting diode (LED). The apparatus further includes a processor in communication with the at least one LED in each light emitting unit, and user input controls in communication with the processor for controlling the light emitting units, such that a light color displayed by each light emitting unit can vary with time.

In accordance with one aspect of the present invention, each light emitting unit contains three LEDs, with each of the three LEDs emitting a different one of three primary colors. A light diffuser can be included in each light emitting unit for blending the colors provided by each LED. The array can include any number of light emitting units, typically between four and sixty-four units. The light emitting units can be square, rectangular, or any other shape. The housing can also have any shape suitable for the intended application, such as square, rectangular, or wavelike. The light apparatus can be free-standing or arranged to be mounted to a wall. Further, a remote control can be provided that includes one or more user input controls for controlling the operation of the light emitting units.

The light apparatus according to the present invention can include various features, such as a speaker and a sound sensor disposed within the housing in communication with the processor. The sound sensor can be configured to provide sound input to the processor, such that operation of the light emitting units is responsive to the sound input. Furthermore, the sensitivity of the sound sensor can be adjustable. The light apparatus can also include a clock in communication with the processor. Additionally, a light sensor can be provided in communication with the processor for operating the light emitting units according to a detected light threshold. The processor may include memory storing at least one algorithm for operation of the light emitting units alone or together with one or more additional features.

Various user input controls are contemplated according to the present invention. A program control is provided for selecting a preprogrammed algorithm for operation of the light emitting units. A pause control can be provided for pausing operation of the light emitting units. A timer control can be provided for selecting a period of operation of the light emitting units. A speed control can be provided for selecting a speed at which the light color of each light emitting unit is varied. A color control can be provided for adjusting the light color and intensity of the light emitting units.

The light apparatus according to the present invention can include various other components as well. For example, a clock radio can be provided in communication with the processor. The clock can include an alarm function, where operation of the light emitting units is initiated upon transmission of an alarm signal from the clock to the processor. The light apparatus of the present invention can be embodied as a night light, where a connector is provided on the housing and arranged to be received in a wall receptacle for powering the night light. The light apparatus can also be provided in combination with a fountain. In this aspect of the present invention, the housing includes a reservoir arranged to hold a fluid, such as water, and a pump having an inlet in communication with the reservoir and an outlet disposed adjacent to the array of light emitting units.

The present invention contemplates several embodiments for controlling the intensity of an LED. One apparatus includes a housing and at least one light emitting unit arranged within the housing and containing at least one LED. A variable frequency signal generator operable to generate a variable frequency signal, such as a square wave or sinusoidal wave, is provided. A low pass filter is provided in communication with the variable frequency generator and the LED, where the low pass filter has a cutoff frequency defining a frequency response characteristic. Control logic is provided in communication with the variable frequency signal generator for controlling a frequency of the variable frequency signal, where the intensity of the LED is varied by changing the frequency of the variable frequency signal in relation to the cutoff frequency.

In another embodiment of the present invention, a method for controlling an intensity of an LED includes generating a variable frequency signal, passing the variable frequency signal through a filter having a gain which varies as a function of frequency, and varying the frequency of the signal such that at least one component of the variable frequency signal is attenuated by the variable gain so as to modify the amount of electrical power delivered to the LED.

In another embodiment of the present invention, an apparatus for controlling an light intensity of an LED includes a housing and at least one light emitting unit, arranged within the housing, containing the LED. A signal generator generates a variable pulse density signal. A multivibrator generates a pulse of set duration each time a clock edge is detected on the variable pulse density signal. Control logic controls the pulse density of the variable pulse density signal.

In another embodiment of the present invention, a method for controlling the intensity of an LED includes generating a variable pulse density signal. A drive signal is generated including a pulse of fixed duration based on at least one edge of each pulse in the variable pulse density signal. The drive signal is supplied to the LED. The pulse density is varied so as to modify an amount of electrical power delivered to the at least one LED.

In another embodiment of the present invention, an apparatus for controlling an LED includes a pulse signal generator for generating a first variable pulse density signal and a sample signal generator for generating a sample signal. A flip-flop generates a second variable pulse density signal for driving the LED in response to the first variable pulse density signal and the sample signal. Control logic controls the sample signal and a pulse density of the first variable pulse density signal.

In another embodiment of the present invention, a method for controlling the intensity of an LED includes generating a first variable pulse density signal and generating a sample signal. The first variable pulse density signal and the sample signal are supplied to a flip-flop, which generates a second variable pulse density signal for powering the LED.

In another embodiment of the present invention, an apparatus for controlling the intensity of an LED includes a signal generator in communication with the LED. The signal generator produces a variable pulse density signal. Control logic controls a pulse density of the variable pulse density signal to vary the intensity of the LED.

In another embodiment of the present invention, a method for controlling the intensity of an LED includes generating a variable pulse density signal and supplying the variable pulse density signal to the at least one LED. The pulse density is varied so as to modify an amount of electrical power delivered to the LED.

In another embodiment of the present invention, an apparatus for controlling the intensity of a plurality of LEDs includes a signal generator for generating a signal having a continuously variable voltage. A digital number generator generates a digital signal. A decoder receives the digital signal from the digital number generator. A plurality of sample-and-hold circuits are also included. Each sample-and-hold circuit is connected to at least one of the plurality of LEDs. The intensity of a different subset of the LEDs is varied by changing the continuously variable voltage and by setting the appropriate output from the decoder.

In another embodiment of the present invention, a method for controlling the intensity of an LED includes generating an analog control signal and generating a digital signal. At least one sample signal is generated from the digital signal. The analog control signal and the sample signal are supplied to a sample-and-hold circuit, which generates a second analog control signal for supplying the LED. The analog control signal is varied so as to modify an amount of electrical power delivered to the at least one LED.

In another embodiment of the present invention, an apparatus for controlling the intensity of an LED includes a PWM signal generator operable to generate a first pulse width modulated (PWM) signal. A sample signal generator generates a sample signal. A flip-flop generates a second PWM signal for driving the at least on LED in response to the first PWM signal and the sample signal. Control logic controls the sample signal and a duty cycle of pulses of the first PWM signal.

In another embodiment of the present invention, a method for controlling the intensity of an LED includes generating a first pulse width modulated (PWM) signal and generating a sample signal. The first PWM signal and the sample signal are supplied to a storage device which generates a second PWM signal. The LED is driven with a signal based on the second PWM signal.

### BRIEF DESCRIPTION OF THE DRAWINGS

FIG. 1 is a perspective view of a light apparatus according to the present invention;

FIG. 2 is a top plan view of the light apparatus of FIG. 1 depicting one embodiment of a control panel;

FIG. 3 is a top plan view of the light apparatus of FIG. 1 depicting another embodiment of a control panel;

FIG. 4 is a block diagram showing components of the light apparatus according to the present invention;

FIG. 5 is a perspective view of a light apparatus according to another aspect of the present invention, the light apparatus configured with a horizontal display;

FIG. 6 is a front elevational view of a light apparatus according to another aspect of the present invention, the light apparatus having a clock and an AM/FM radio;

FIG. 7 is a perspective view of a night light apparatus according to another aspect of the present invention;

FIG. 8 is a perspective view of a light apparatus according to another aspect of the present invention, the light apparatus arranged to be mounted to a wall;

FIG. 9 is a front elevational view of a remote control for use with any embodiment of the light apparatus according to the present invention;

FIG. 10 is a perspective view a light apparatus according to another aspect of the present invention having a housing with a wave configuration;

FIG. 11 is a perspective view of a light apparatus according to another aspect of the present invention, the light apparatus including a fountain;

FIG. 12 is an exploded view of the light apparatus of FIG. 7 illustrating the assembly of diffuser and shade components;

FIG. 13 is a cross sectional view of the diffuser and shade assembly shown in FIG. 12;

FIG. 14 is a block diagram illustrating variable frequency control for controlling the intensity of an LED according to an aspect of the present invention;

FIG. 15 is a frequency plot of a low pass filter for controlling the intensity of an LED;

FIG. 16 is a plot of a square wave that can be used as an input to a low pass filter;

FIGS. 17 and 18 are plots illustrating the effect of passing a square wave of differing fundamental frequencies through a low pass filter for controlling light intensity;

FIG. 19 is a plot illustrating pulse density control according to an aspect of the present invention;

FIG. 20 is a block diagram illustrating a circuit that employs pulse density control to control the intensity of an LED according to an aspect of the present invention;

FIG. 21 is a block diagram illustrating another circuit that employs pulse density control to control the intensity of an LED according to an aspect of the present invention;

FIG. 22 is a block diagram illustrating yet another circuit that employs pulse density control to control the intensity of an LED according to an aspect of the present invention;

FIG. 23 is a block diagram illustrating a circuit that can be used to implement multiplexed analog control to control the intensity of an LED according to an aspect of the present invention;

FIG. 24 is a block diagram illustrating a circuit that employs pulse width modulation to control the intensity of an LED according to an aspect of the present invention; and

FIG. 25 is a circuit diagram illustrating one example of a transistor driver circuit that may be used in combination with any of the previous circuits to provide power to an LED according to an aspect of the present invention.

### DETAILED DESCRIPTION OF THE EMBODIMENTS OF THE PRESENT INVENTION

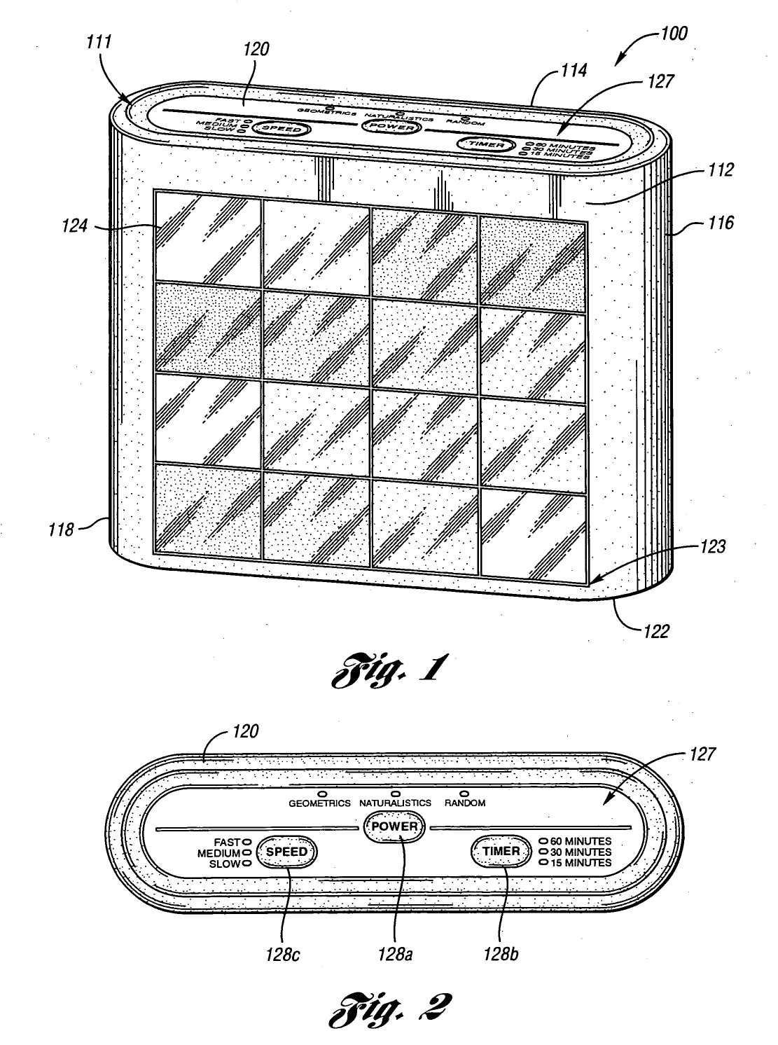

Referring first to FIG. 1, a light apparatus 100 is illustrated according to an aspect of the present invention. Light apparatus 100 has a housing 111 that generally comprises a front side 112, a back side 114, a right side 116, a left side 118, a top side 120, and a bottom side 122. As depicted in FIG. 1, front side 112, back side 114, top side 120 and bottom side 122 may be essentially flat, while right side 116 and left side 118 may be rounded for aesthetic reasons. Of course, it is understood that other shapes of housing 111 are fully contemplated according to the present invention. Light apparatus 100 is designed to stand vertically on bottom side 122, and can include a standard power cord (not shown) for plugging into a wall outlet or alternatively be battery-operated.

Front side 112 generally comprises a display area 123 having a plurality of light emitting units 124. In the example shown in FIG. 1, a total of sixteen light emitting units 124 are provided in four rows and four columns. Of course, light apparatus 100 according to the present invention can have fewer or greater numbers of light emitting units 124, and the plurality of light emitting units 124 need not be arranged as an equal number of rows and columns. In accordance with the present invention, it is fully contemplated that any number of light emitting units 124 may be implemented to meet the design criteria of a particular application. Furthermore, while light emitting units 124 are depicted herein as being square in shape, it is understood that light emitting units 124 can be of any shape, such as rectangles, circles, octagons, hexagons, and others.

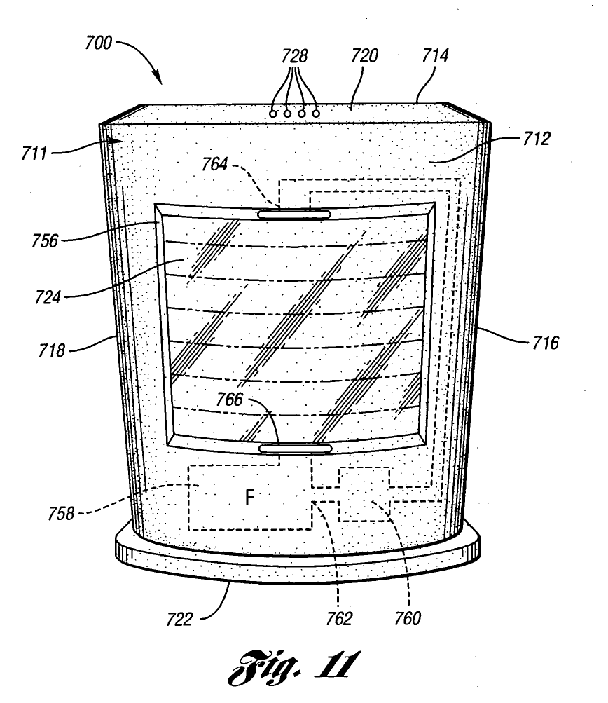

Each of the light emitting units 124 contains at least one light emitting diode (LED) 16, as best shown in FIG. 13. According to one aspect of the present invention, each light emitting unit 124 contains three LEDs, each LED emitting one of the three primary colors. This configuration allows any of the light emitting units 124 to emit any color in the visible spectrum. Light apparatus 100 according to the present invention is operable to display a light show that is visually stimulating and/or relaxing to a viewer. The light show can comprise patterns of changing colors in a horizontal direction, vertical direction, or combinations thereof, such as various colors chasing themselves around display area 123 or fading in and out at different rates. The light show may be controlled by preprogrammed algorithms representing a number of modes, such that a user can select which show he/she would like to view by selecting the appropriate mode, as described further below.

Referring now to FIG. 2, a control panel 127 of light apparatus 100 is illustrated. Control panel 127 can be disposed on any part of housing 111, such as top side 120 as illustrated herein. Control panel 127 typically comprises a number of user input controls, such as buttons 128a-c. As shown, there may be a POWER button 128a for turning light apparatus 100 on and off, a TIMER button 128b for setting a timer for the operation of light apparatus 100, and a SPEED button 128c for controlling the speed at which the light emitting units 124 change colors. TIMER button 128b may be used to select among a number of preprogrammed timer modes, such as a fifteen-minute mode, a thirty-minute mode, or a sixty-minute mode. SPEED button 128c may be used to select between a number of preprogrammed speed modes, such as a slow mode, a medium mode, or a fast mode. There also may be a number of color display modes preprogrammed into light apparatus 100 as described in greater detail below. The user may select among these preprogrammed color display modes, such as by depressing POWER button 128a to cycle through the modes. While three buttons 128a-c have been described, any number of buttons may be employed to meet the design criteria of a particular application.

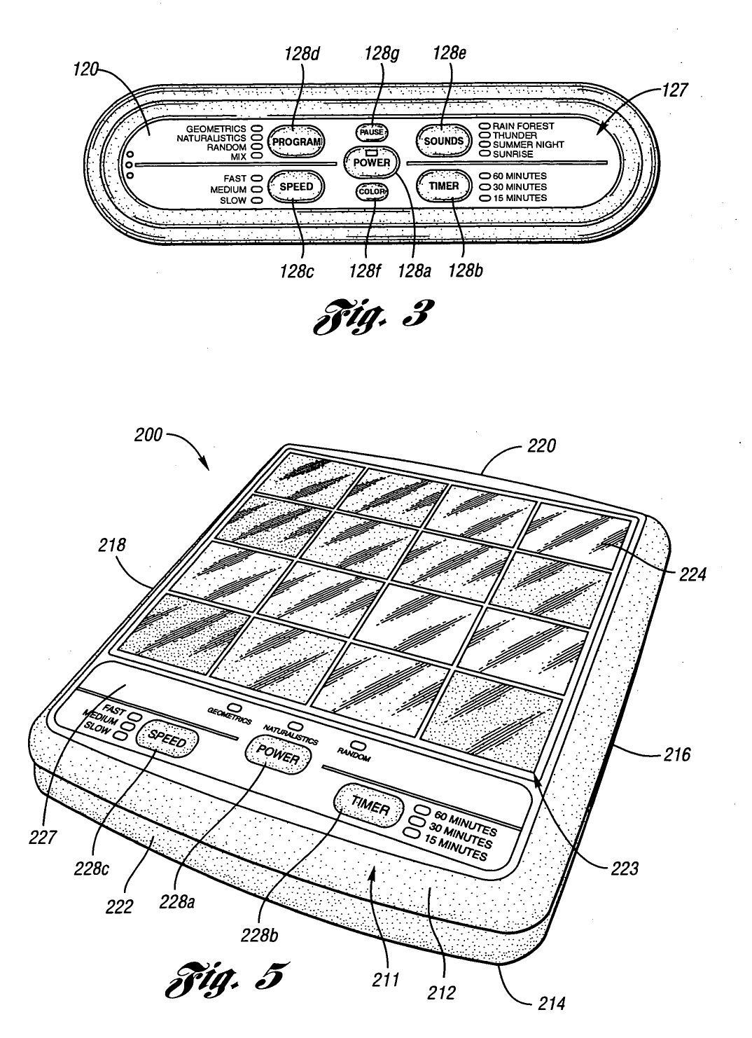

Another control panel 127 is illustrated in FIG. 3. In this example, top side 120 may comprise a number of buttons 128a-g that may include a PROGRAM button 128d, a SOUND button 128e, a COLOR button 128f, and a PAUSE button 128g in addition to buttons 128a-c described above. PROGRAM button 128d may be used to select among a number of lighting modes, such as a GEOMETRICS mode, a NATURALISTICS mode, a RANDOM mode, and a MIX mode. These various lighting modes represent preprogrammed algorithms that control what patterns, pseudo-random patterns, or random patterns light apparatus 100 uses for the light display. SOUND button 128e may be used to select from a number of sound modes, such as a RAINFOREST mode, a THUNDER mode, a SUMMER NIGHT mode, and a SUNRISE mode. These sound modes represent preprogrammed algorithms or prerecorded sounds which are emitted by light apparatus 100. COLOR button 128f may be used to select the color palette of the light emitting units 124 as well as the intensity of the light, and PAUSE button 128g may be used to pause operation of the light display after the lighting mode is selected. While a number of control buttons and modes have been described herein, it is understood that any number and type of buttons and modes may be implemented in accordance with the present invention.

Referring next to FIG. 4, a block diagram of the components of light apparatus 100 according to the present invention is illustrated. As shown, each light emitting unit 124 is in communication with a processor 130 provided in housing 111. Processor 130 includes a memory 132 for storing at least one preprogrammed lighting algorithm as described above. User input controls 128 are also in communication with processor 130 for controlling the operation of the light emitting units 124. Light apparatus 100 can further include a speaker 134 in communication with processor 130 for emitting sound in accordance with a user-selected mode, and a sound sensor 136 in communication with processor 130 for detecting ambient sound in the area of light apparatus 100. In accordance with one aspect of the present invention, the operation of the light emitting units 124 can be responsive to the sounds detected by sound sensor 136, such that the light display can be coordinated with music or other sounds emanating from speaker 134 as well as other sounds having a source external to light apparatus 100. Furthermore, sound sensor 136 can have an adjustable sensitivity or sound threshold, with the resulting responsiveness of the light display varied according to the threshold. A clock 138 is provided in communication with processor 130 for providing the timer functionality described above. Still further, a light sensor 140 can be provided in communication with processor 130 for controlling the operation of the light emitting units 124 in accordance with a light threshold, which can also be adjustable. For example, light emitting units 124 can be activated when the room in which it is contained reaches a certain darkness, such as for a night light as described below with reference to FIG. 7. Although the above components have been described with reference to light apparatus 100, it is understood that this description is equally applicable to the additional embodiments described below.

With reference to FIG. 5, an alternative light apparatus 200 is illustrated. Light apparatus 200 is similar to light apparatus 100 shown in FIG. 1 and can include all the features described above, wherein like components have like reference numerals except for the substitution of a “2” prefix. Light apparatus 200 is designed to lie on back side 214 on a table or other horizontal support surface such that display area 223 is parallel to the table. Light apparatus 200 preferably includes control buttons 228a-228c on front side 212 for easy user access, although it is understood that buttons 228a-228c could alternatively be disposed on another side of light apparatus 200.

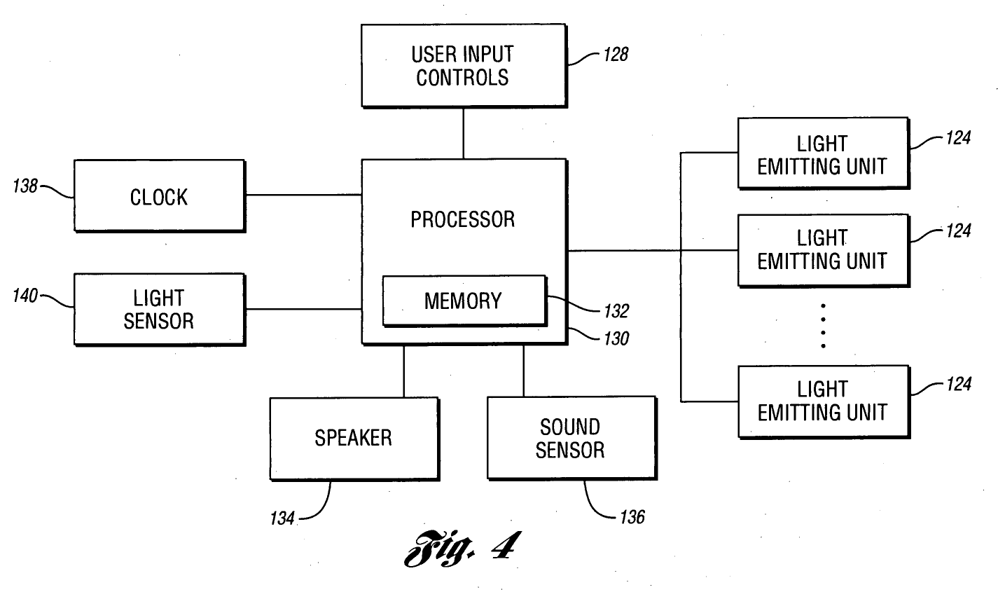

Referring now to FIG. 6, another light apparatus 300 according to the present invention is illustrated, wherein reference numerals correspond to like elements from light apparatus 100 except for the substitution of a “3” prefix. Light apparatus 300 can include all the features of light apparatus 100 and light apparatus 200, and further includes an AM/FM clock radio 342 and associated control buttons 344 as described below. As with light apparatus 100, the array of light emitting units 324 is preferably located on front side 312 of housing 311, and light apparatus 300 is designed to stand vertically on bottom side 322. It is understood, however, that light apparatus 300 could alternatively be configured to lie horizontally, such as with light apparatus 200. Information display 330 and control buttons 332 are also depicted herein as disposed on front side 312, but could of course be disposed on another side of housing 311 in accordance with the present invention.

With continuing reference to FIG. 6, clock radio 342 may be an LED or liquid crystal display (LCD) designed to display time and other information. In addition to the functions described above with reference to light apparatus 100 and 200, control buttons 344 are provided to control clock radio functions as is known in the art. Referring again to FIG. 4, clock 138 can provide an alarm signal to processor 130 such that light apparatus 300 may awaken a user by providing a light show with light emitting units 324. The light show could begin with a very dim lights that slowly increase in intensity until the light show is bright enough to wake up the user. Likewise, the light show could begin with slowly moving lights which gradually increase in speed in order to awaken the user. The light show may be accompanied by music that increases in volume with the increase in light intensity or speed.

Turning next to FIG. 7, a night light apparatus 400 is shown in further accordance with the present invention. Once again, night light apparatus 400 can include all the features of light apparatus 100-300, where like components are designated with like reference numerals except for the substitution of a “4” prefix. Night light apparatus 400 further includes a plug 446 (see FIG. 13) arranged to be received in a standard wall socket for supplying power to night light apparatus 400. Housing 411 can include a number of control buttons 428 as described above, such as on front side 412, for controlling the function of night light apparatus 400. Night light apparatus 400 preferably contains light sensor 140 described with reference to FIG. 4 for controlling the operation of light emitting units 424.

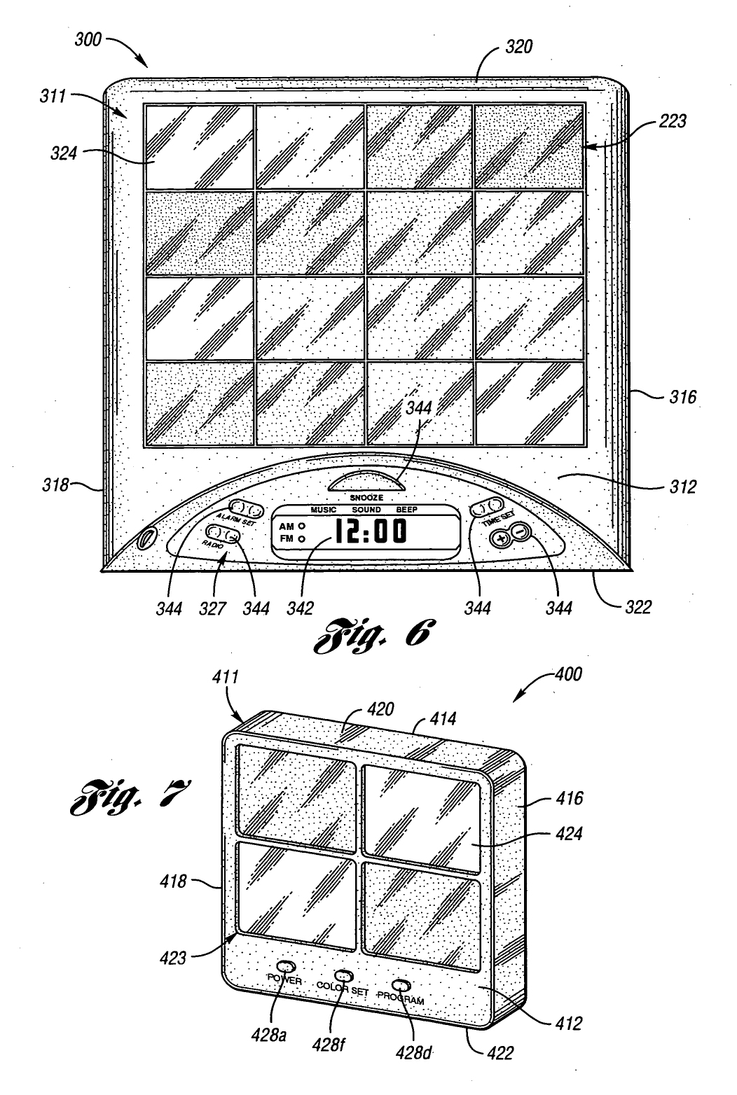

Referring now to FIG. 8, another light apparatus 500 is illustrated in accordance with the present invention. Light apparatus 500 can include all the features of light apparatus 100-400, where like components are designated with like reference numerals except for the substitution of a “5” prefix. Housing 511 of light apparatus 500 preferably has a thinner profile than the light apparatus embodiments described above, and is arranged to be mountable on a wall or other vertical surface. Alternatively, light apparatus 500 can lie on a table or other horizontal support surface. The array of light emitting elements 524 is provided on front side 512, and control buttons 528 are preferably provided on a side of housing 511, such as side 516 depicted herein, so as to be accessible to a user but not otherwise noticeable.

A remote control 550 is illustrated in FIG. 9 that can be used in combination any of the aforementioned light apparatus embodiments, in particular light apparatus 500 shown in FIG. 8. As is known in the art, remote control 550 includes a transmitter (not shown) for sending signals, such as infrared signals, to a receiver (not shown) on light apparatus 100-500 for controlling the operation thereof. Remote control 550 may comprise a number of control buttons 552a-c including, but not limited to, a PROGRAM button 552a, a TIMER button 552b, and a SPEED button 552c as described above. While three control buttons 552a-c have described, any number of buttons may be implemented to meet the design criteria of a particular application.

A light apparatus 600 having a wave configuration is illustrated in FIG. 10 in accordance with the present invention. As before, light apparatus 600 can include all the features of light apparatus 100-500, where like components are designated with like reference numerals except for the substitution of a “6” prefix. Light apparatus 600 comprises a housing 611 having a wavelike construction, wherein light apparatus 600 is preferably designed to stand vertically on bottom side 622. Light apparatus 600 comprises a plurality of vertical, generally rectangular light emitting units 624 that function similar to the light emitting units described above for other light apparatus embodiments 100-500. Of course, the rectangular shape of light emitting units 624 is merely exemplary, and other shapes are fully contemplated in accordance with the present invention.

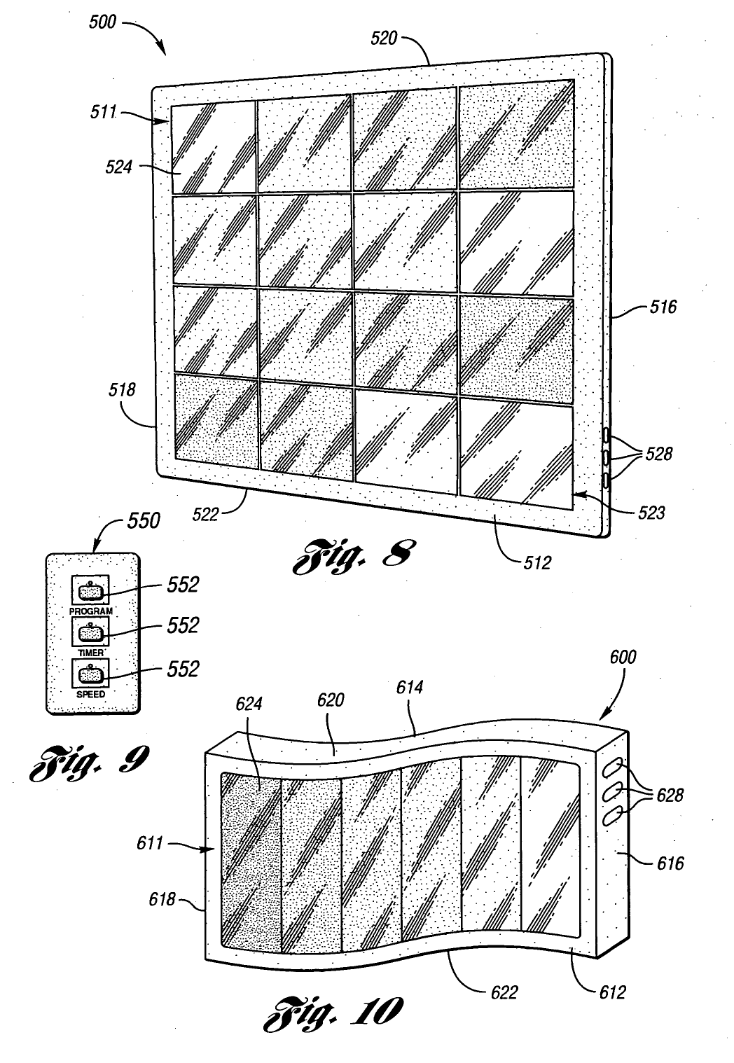

With reference to FIG. 11, a combination light/fountain apparatus 700 is illustrated in accordance with another aspect of the present invention. Light/fountain apparatus 700 can include all the features of light apparatus 100-600, where like components are designated with like reference numerals except for the substitution of a “7” prefix. In this embodiment, light emitting units 724 are disposed within a recessed area 756 of housing 711, and a fluid reservoir 758 and pump 760 are disposed within housing 711 below light emitting units 724. Pump 760 includes an inlet 762 in fluid communication with reservoir 758, and an outlet 764 disposed above light emitting units 724. In operation, fluid F, such as water, is pumped out of reservoir 758 by pump 760, through outlet 764, and flows past light emitting units 724 providing a pleasing visual effect. The fluid F is returned to reservoir 758 via a drain 766 provided at the bottom of recessed area 756. Of course, other configurations wherein a fountain is provided in combination with light emitting units 724 are also fully contemplated.

In accordance with one aspect of the present invention, each of the foregoing light apparatus embodiments 100-700 can include light emitting units 124-724 each containing three LEDs, with each LED emitting a different primary color. When the light exits the light emitting unit 124-724, it is desirable that the light of the three LEDs is blended to produce the desired resultant color. As illustrated in FIGS. 12-13 for night light apparatus 400, this effect may be aided with the use of a diffuser lens 470 and shade 472. As depicted herein, diffuser lenses 470 can be hemispherical in shape and enclose the LEDs, although other shapes are also contemplated. Diffuser lenses 470 can be semi-transparent and have properties that do not permit light of the multiple LEDs contained therein to exit the lens 470 separately without blending to create a resultant color. Each diffuser lens 470 may also be designed such that the light emitted from the LEDs is diffracted so as to emit from the entire area of the lens 470. Shades 472 can be utilized to make the emitted LED light appear more tender and even. Square-shaped shades 472 are illustrated, but it is understood that any shape can be used to meet the design criteria of a particular application. Of course, diffuser lenses 470 and shades 472 can be implemented in any of the light apparatus embodiments 100-700 described herein.

Each light apparatus 100-700 described above functions to produce a light display by controlling a plurality of LEDs disposed therein. The following figures and description disclose various systems and methods that can be employed to control the intensity of the LEDs, such as within any foregoing light apparatus 100-700.

Referring to FIG. 14, a block diagram illustrating variable frequency control for controlling the intensity of an LED according to an aspect of the present invention is shown. The circuit in FIG. 14 generally comprises a microcontroller or microprocessor 10 having one or more outputs 12a-n. Each output 12a-n is connected to an amplifier 13, a low pass filter (LPF) 14, an LED 16, and a current limiting resistor 18. The low pass filter 14 attenuates high frequency components appearing on output 12a based on the frequency of each component. Thus, by changing the frequency of one or more components of a signal on output 12a, the intensity of LED 16 is varied. The signal on output 12a may be sinusoidal, rectangular, triangular or any other periodic shape as well as aperiodic shapes.

In any of the described embodiments, the microprocessor or microcontroller 10 may be any microprocessor or microcontroller or any electronic circuit that is capable of producing a variable frequency output. The microcontroller 10 may generate any type of wave form. In one example, the microcontroller 10 may directly generate a signal on outputs 12a-n for filtering. In another example, microcontroller 10 may generate a signal for controlling an external signal generator as is known in the art.

Referring to FIG. 15, a frequency plot is shown illustrating the frequency response of a typical low pass filter 14. This plot illustrates the effect filter 14 has on input signals as a function of frequency. The spectrum for most low pass filters can be divided into two or more regions based on how they perform in frequency. In the simple case illustrated in FIG. 15, two regions can be defined. For frequencies less than the cutoff frequency, f_{c}, an input signal or signal component suffers little or no relative attenuation. This region is known as the pass band. For frequencies greater than the cutoff frequency, an input signal or signal component suffers an attenuation that increases as the frequency increases. This region is known as the reject band.

For example, a sinusoidal input signal having a frequency f₁, in the pass band may experience almost no relative attenuation when passed through low pass filter 14, as shown in the plot of FIG. 15. In contrast, a sinusoidal signal having a frequency f₂ outside of the pass band may experience considerable relative attenuation when passed through filter 14. The amount of relative attenuation is a function of the order and construction of filter 14 as well as the frequency of the signal component under consideration. For example, the low pass filter 14 may be a passive first order low pass filter. Such a filter can be constructed with a capacitor in series with a resistor if the output is taken across the capacitor. However, any order low pass filter may be used to meet the design criteria of a particular application. The construction of both active and passive low pass filters is well known in the art.

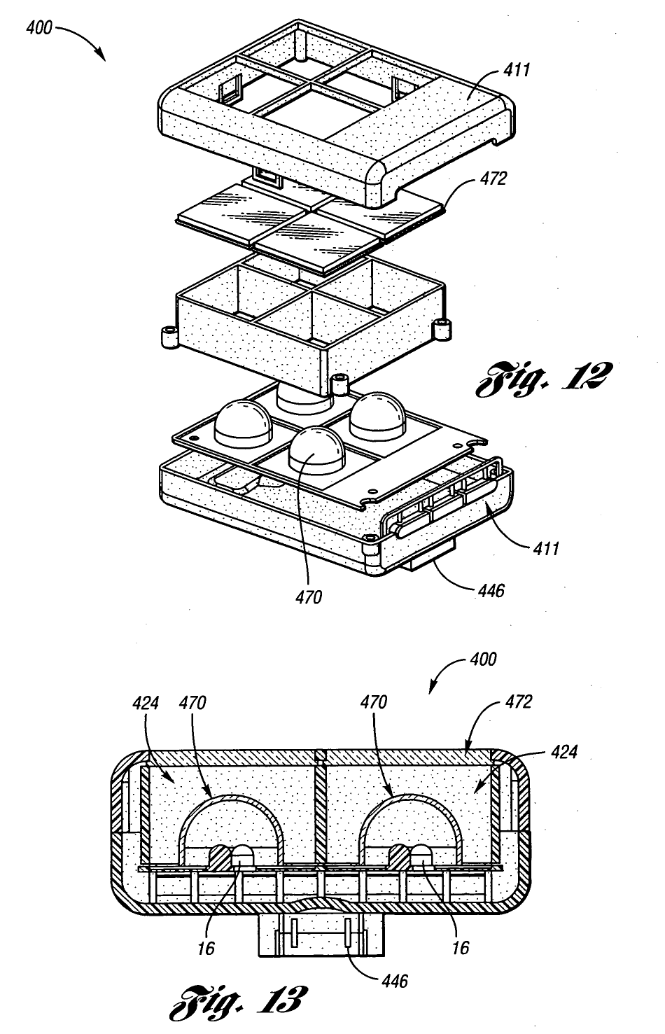

Referring to FIG. 16, a plot of a square wave is shown where the square wave has a period inversely proportional to fₛ, the square wave fundamental frequency. Any periodic waveform, including the square wave of FIG. 16, may be represented mathematically by sunning sinusoids at proper amplitudes that are integer multiples of the fundamental frequency. Such a square wave passed through low pass filter 14 will experience varying modifications depending on the relationship between the fundamental frequency of the square wave and the characteristics of low pass filter 14, predominantly the cutoff frequency. The fundamental frequency of the square wave shown in FIG. 16 may be varied by microcontroller 10, thereby controlling the amount of light emitted by LED 16.

As will be recognized by one of ordinary skill in the art, the filter need not be a low pass filter. Any filter with variable attenuation over a range of frequencies of interest may be used to control the amount of power delivered to and, thereby, the intensity of light generated by, an LED.

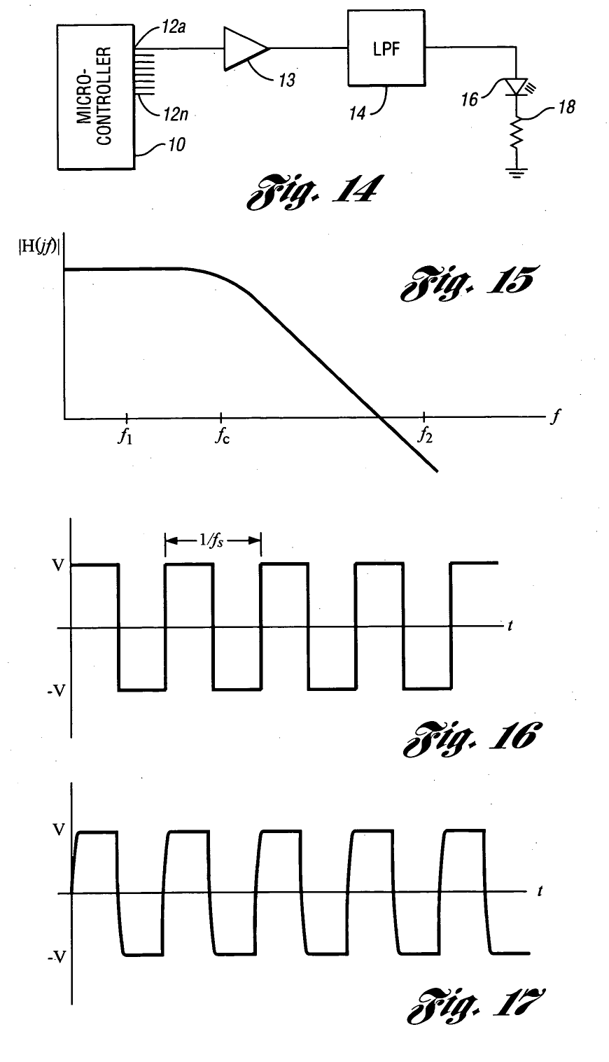

Referring to FIGS. 17 and 18, the effect of passing a square wave of differing fundamental frequencies through a low pass filter for controlling light intensity is shown. If the fundamental frequency of the square wave falls well within the pass band of low pass filter 14, the resulting signal will look substantially like the input signal, as in FIG. 17. In this case, most of the power seen at the input of low pass filter 14 is passed to the output of low pass filter 14 to LED 16. If the fundamental frequency of the square wave falls in the reject band, the resulting signal will be highly distorted, as in FIG. 18. In this case, much of the power seen at the input of low pass filter 14 is dissipated as heat by low pass filter 14 and is therefore not supplied to LED 16. Thus, by varying the frequency of a generated signal, microcontroller 10 can vary the intensity of light emitted by LED 16.

A plot illustrating pulse density control according to an aspect of the present invention is shown in FIG. 19. The signal shown includes a number of uniform pulses each having a width, d. Each of the pulses is shown occurring at different times t₁, t₂, . . . . A property of the human eye known as persistence of vision averages out the pulsed light emitted by an LED. If these pulses were used to drive an LED, the average intensity of light emitted by the LED would be determined by the density of the pulses. So, for the purpose of illustration, light emitted during a span of time including pulses at times t₁, t₂, t₃, and t₄ would appear dimmer than light emitted during a span of time including pulses at times t₅, t₆, t₇ and t₈. Thus, by controlling the average density of pulses over a period of time, the intensity of light emitted by an LED, as perceived by a human, can be varied.

Referring to FIG. 20, a block diagram illustrating a circuit that employs pulse density control to control the intensity of an LED according to an aspect of the present invention is shown. The circuit shown in FIG. 20 includes a microcontroller 20 having one or more outputs 22a-n. Each output controls a monostable multivibrator, or one-shot, 24, an LED 16, and a current limiting resistor 28. One-shot 24 generates a fixed width pulse at its output when an appropriate edge, rising or falling, is received at its input. The microcontroller 20 may supply a control signal from the output 22a over a control line to one-shot 24 having an appropriate edge at each time a pulse is desired. Since LED 16 is coupled to the output of one-shot 24, each of the pulses generated by one-shot 24 is supplied to the LED 16. If the period between any two pulses is short enough, the intensity of LED 16 can be varied without causing noticeable flicker.

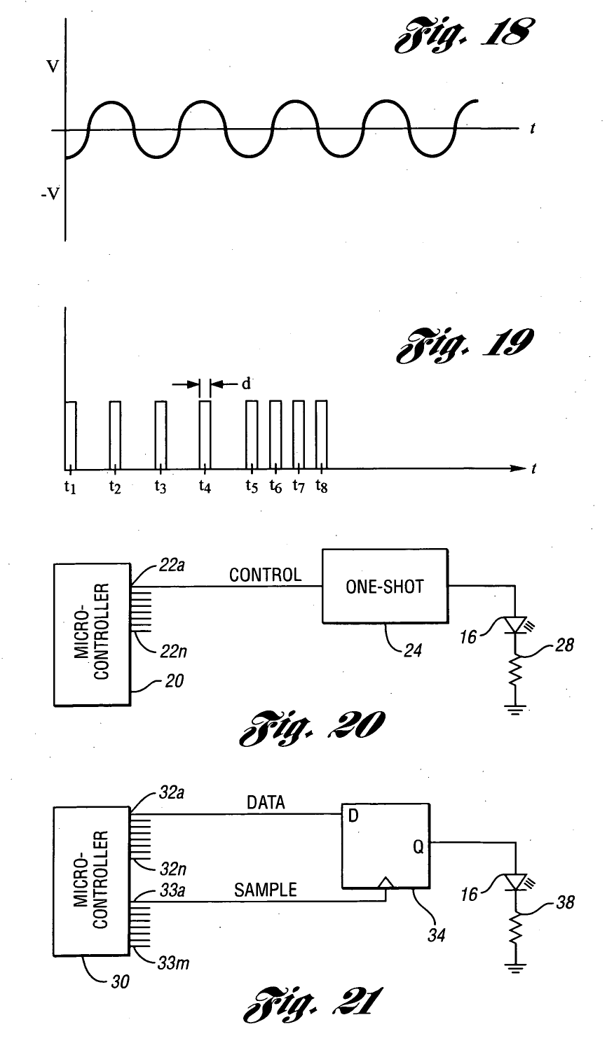

Referring next to FIG. 21, a block diagram illustrating another circuit that employs pulse density control to control the intensity of an LED according to an aspect of the present invention is shown. The circuit illustrated in FIG. 21 includes a microcontroller 30 having one or more data outputs 32a-n and one or more sample outputs 33a-m. One data output 32a-n is connected to a D input and one sample output 33a-m is connected to a clock input of at least one D flip-flop 34. Each flip-flop 34 has an output, Q, which drives one or more sets of LEDs 16 and current limiting resistors 38.

Typically, a plurality of LEDs 16 would be implemented with a plurality of D flip-flops 34 such that the microcontroller 30 controls a plurality of LEDs. The output 32a-n of the microcontroller 30 may be an n-bit output. In one example, n-bit output 32a-n may be an 8-bit data output. The data output 32a-n may be 8 bits wide and may be coupled to eight D flip-flops 34. The eight D flip-flops 34 may be controlled by a common clock signal coupled to one of the sample outputs 33a-m. In one example, a plurality of multi-bit flip-flop IC packages or cells may be applied to this design. The sets of data inputs of the multi-bit D flip-flop IC packages may be coupled together in parallel and a separate bit of the second output 33a-m of the microcontroller 30 may supply each package with a sample signal. Using this method, a multiplexed data implementation may be achieved that may allow n×m LEDs 16 or sets of LEDs 16 to be controlled using the circuit shown in FIG. 21. Each flip-flop 24 may be used to sample and store a data signal, such as the pulse density signal illustrated in FIG. 19.

A block diagram illustrating another circuit that employs pulse density control to control the intensity of an LED according to an aspect of the present invention is shown in FIG. 22. The circuit includes microcontroller 40, which has one or more outputs 42a-n. The output 42a-n typically comprises a multi-bit output having n bits. The output 42a-n may be configured to implement a direct data method where the output 42a-n directly supplies a variable pulse density control signal, as illustrated in FIG. 19. In one example, the output 42a-n may be coupled to n sets of LEDs 16 and current limiting resistors 48 through a driver circuit, not shown.

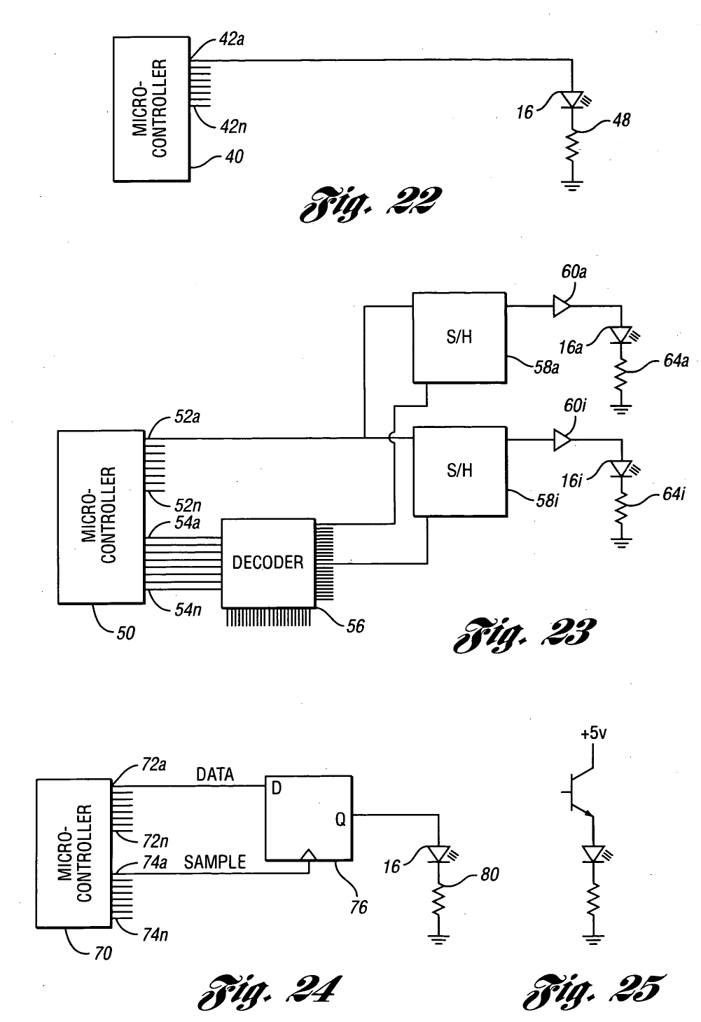

Referring to FIG. 23, a block diagram is shown illustrating a multiplexed analog control method. The circuit shown in FIG. 23 includes a microcontroller 50 having one or more analog outputs 52a-m and a plurality of selecting outputs 54a-n, a decoder 56, a plurality of sample-and-hold circuits 58a-i, a plurality of amplifiers 60a-i, a plurality of LEDs 16a-i, and a plurality of current limiting resistors 64a-i. Each analog output 52a-m of microcontroller 50 generates an analog signal indicative of a desired LED intensity level. Alternatively, microcontroller 50 may generate digital outputs which are supplied to one or more external digital-to-analog converters. Select outputs 54a-n of microcontroller 50 are coupled to inputs of the decoder 56. The decoder 56 asserts one of its outputs based on the value received from select outputs 54a-n.

Each sample-and-hold circuit 58a-i has a signal input connected to an analog signal such as one of analog outputs 52a-m. Each sample-and-hold circuit 58a-i also has a sample input connected to one output from decoder 56. When this input is asserted, the sample-and-hold circuit capacitively stores the voltage on its input and presents this voltage to an LED 16 through an output amplifier 60.

In operation, microcontroller 50 generates an analog voltage for a particular LED 16 on an output 52a-m associated with LED 16a-i. Microcontroller 50 then outputs to decoder 56 the appropriate number on outputs 54a-n to select sample-and-hold 58a-i associated with the desired LED 16a-i. Microcontroller 50 can then set analog output 52a-m for the next desired LED 16a-i. If a large number of LEDs 16a-i are to be controlled, microcontroller 50 may control a plurality of analog outputs 52a-m. This has the advantage of not basing the scan rate on the voltage change rate of an individual digital-to-analog converter.

A block diagram illustrating a circuit that employs pulse width modulation to control the intensity of an LED according to an embodiment of the present invention is shown in FIG. 24. This circuit includes microcontroller 70 having one or more data outputs 72a-n and one or more sample outputs 74a-m. One data output 72a-n is connected to a D input and one sample output 74a-m is connected to a clock input of at least one D flip-flop 76. Each flip-flop 76 has an output, Q, which drives one or more sets of LEDs 16 and current limiting resistors 80.

Typically, a plurality of LEDs 16 would be implemented with a plurality of D flip-flops 76 such that the microcontroller 70 controls a plurality of LEDs. The output 72a-n of the microcontroller 70 may be an n-bit output. In one example, n-bit output 72a-n may be an 8-bit data output. The data output 72a-n may be 8 bits wide and may be coupled to eight D flip-flops 76. The eight D flip-flops 76 may be controlled by a common clock signal coupled to one of the sample outputs 74a-m. In one example, a plurality of multi-bit flip-flop IC packages or cells may be applied to this design. The sets of data inputs of the multi-bit D flip-flop IC packages may be coupled together in parallel and a separate bit of the second output 74a-m of the microcontroller 70 may supply each package with a sample signal. Using this method, a multiplexed data implementation may be achieved that may allow n×m LEDs 16 or sets of LEDs 16 to be controlled using the circuit shown in FIG. 24. Each flip-flop 76 may be used to sample and store a data signal, such as a pulse width modulated signal.

Referring lastly to FIG. 25, a circuit diagram is shown illustrating one example of a transistor driver circuit that may be used in combination with any of the previous circuits to provide power to an LED.

While each of the circuit diagrams discussed above illustrates, in one example, a defined number of inputs and outputs for each component, it will be understood by those skilled in the art that the number of inputs and outputs described can be increased or decreased by using the appropriate microcontroller and supporting structure, thus shrinking or enlarging the scopes of the circuits and allowing the invention to control a greater or lesser number of LEDs.

In the foregoing description, certain detailed aspects of the circuits described that are well known to those skilled in the art have been omitted, such as power and ground connections for the microcontrollers and other circuits, transistor driver circuits that may be necessary to supply the power to LEDs, and other electronic circuits that facilitate the implementation of the present invention. In addition, multiple LEDs may be driven in parallel by any of the embodiments illustrated such that language referring to a single LED applies equally well to sets of LEDs.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

1. A light apparatus, comprising:
a housing;
an array of light emitting units integrally formed within the housing, each light emitting unit containing at least one light emitting diode (LED);
a processor in communication with the at least one LED in each light emitting unit; and
user input controls in communication with the processor for controlling the light emitting units such that a light color displayed by each light emitting unit can vary with time.

2. The light apparatus according to claim 1, wherein each light emitting unit includes three LEDs each emitting a different one of three primary colors.

3. The light apparatus according to claim 1, further comprising a speaker disposed within the housing in communication with the processor.

4. The light apparatus according to claim 1, further comprising a sound sensor disposed within the housing in communication with the processor.

5. The light apparatus according to claim 4, wherein the sound sensor provides sound input to the processor, such that operation of the light emitting units is responsive to the sound input.

6. The light apparatus according to claim 5, wherein a sensitivity of the sound sensor is adjustable.

7. The light apparatus according to claim 1, further comprising a clock in communication with the processor.

8. The light apparatus according to claim 1, wherein the user input controls include a timer control for selecting a period of operation of the light emitting units.

9. The light apparatus according to claim 1, wherein the user input controls include a speed control for selecting a speed at which the light color of each light emitting unit is varied.

10. The light apparatus according to claim 1, wherein the user input controls include an intensity control for adjusting an intensity of the light color of each light emitting unit.

11. The light apparatus according to claim 1, wherein the processor includes memory for storing at least one algorithm for operation of the light emitting units.

12. The light apparatus according to claim 11, wherein the user input controls include a program control for selecting the at least one algorithm for operation of the light emitting units.

13. The light apparatus according to claim 1, wherein the user input controls include a pause control for pausing operation of the light emitting units.

14. The light apparatus according to claim 1, wherein the user input controls include a color control for adjusting the light color of the light emitting units.

15. The light apparatus according to claim 1, wherein the light apparatus is free-standing.

16. The light apparatus according to claim 1, wherein the light apparatus is arranged to be mounted to a wall.

17. The light apparatus according to claim 1, further comprising a remote control in communication with the processor, the remote control including one or more of the user input controls for controlling the operation of the light emitting units.

18. The light apparatus according to claim 1, further comprising a light diffuser contained within each light emitting unit.

19. The light apparatus according to claim 1, wherein the array comprises between four and sixty-four light emitting units.

20. The light apparatus according to claim 1, wherein the light emitting units are generally square in shape.

21. The light apparatus according to claim 1, wherein the light emitting units are generally rectangular in shape.

22. A tabletop light apparatus, comprising:
a housing;
a plurality of adjacent light emitting units integrally formed within the housing, each light emitting unit containing three light emitting diodes (LEDs) each emitting a different one of three primary colors;
a processor in communication with the at least one LED in each light emitting unit;
a clock disposed within the housing in communication with the processor;
a radio disposed within the housing in communication with the processor; and
user input controls in communication with the processor for controlling the light emitting units such that a light color displayed by each light emitting unit can vary with time.

23. The tabletop light apparatus according to claim 22, wherein the clock includes an alarm function and operation of the light emitting units is initiated upon transmission of an alarm signal from the clock to the processor.

24. The tabletop light apparatus according to claim 22, further comprising a speaker disposed within the housing in communication with the processor.

25. The tabletop light apparatus according to claim 22, further comprising a sound sensor disposed within the housing in communication with the processor.

26. The tabletop light apparatus according to claim 22, wherein the user input controls include a timer control for selecting a period of operation of the light emitting units.

27. The tabletop light apparatus according to claim 22, wherein the user input controls include a speed control for selecting a speed at which the light color of each light emitting unit is varied.

28. The tabletop light apparatus according to claim 22, wherein the processor includes memory for storing at least one algorithm for operation of the light emitting units, and the user input controls include a program control for selecting the at least one algorithm for operation of the light emitting units.

29. The tabletop light apparatus according to claim 22, wherein the user input controls include a color control for adjusting the light color emitted by the light emitting units.

30. A night light comprising:
a housing having a front side and an opposed rear side, the rear side having a connector arranged to be received in a wall receptacle for powering the night light;
a plurality of light emitting units integrally formed within the front side of the housing, each light emitting unit containing at least one light emitting diode (LED);
a processor in communication with the at least one LED in each light emitting unit; and
user input controls in communication with the processor for controlling the light emitting units such that a light color displayed by each light emitting unit can vary with time.

31. The night light according to claim 30, wherein each light emitting unit includes three LEDs each emitting a different one of three primary colors.

32. The night light according to claim 30, wherein the array includes four light emitting units which are generally square in shape.

33. The night light according to claim 30, further comprising a light sensor in communication with the processor for operating the light emitting units according to a detected light threshold.

34. The night light according to claim 30, wherein the user input controls include a timer control for selecting a period of operation of the light emitting units.

35. The night light according to claim 30, wherein the user input controls include a speed control for selecting a speed at which the light color of each light emitting unit is varied.

36. The night light according to claim 30, wherein the processor includes memory for storing at least one algorithm for operation of the light emitting units, and the user input controls include a program control for selecting the at least one algorithm for operation of the light emitting units.

37. The night light apparatus according to claim 22, wherein the user input controls include a color control for adjusting the light color emitted by the light emitting units.

38. A light apparatus comprising:
a housing having a generally wave-like configuration;
an array of adjacent, generally rectangular light emitting units affixed within the housing, each light emitting unit containing at least one light emitting diode (LED);
a processor in communication with the at least one LED in each light emitting unit; and
user input controls in communication with the processor for controlling the light emitting units such that a light color displayed by each light emitting unit can vary with time.

39. A combination fountain and light apparatus, comprising:
a housing including a reservoir which is arranged to hold a fluid;
a plurality of light emitting units integrally formed within the housing, each light emitting unit containing at least one light emitting diode (LED);
a processor in communication with the at least one LED in each light emitting unit;
user input controls in communication with the processor for controlling the light emitting units such that a light color displayed by each light emitting unit can vary with time; and
a pump provided in the housing, the pump having an inlet in communication with the reservoir and an outlet disposed adjacent to the plurality of light emitting units.

40. An apparatus for controlling an intensity of a light emitting diode (LED), the apparatus comprising:
a housing;
at least one light emitting unit arranged within the housing and containing at least one LED;
a variable frequency signal generator operable to generate a variable frequency signal;
a low pass filter in communication with the variable frequency generator and the at least one LED, the low pass filter having a cutoff frequency defining a frequency response characteristic; and
control logic in communication with the variable frequency signal generator for controlling a frequency of the variable frequency signal, wherein the intensity of the at least one LED is varied by changing the frequency of the variable frequency signal in relation to the cutoff frequency.

41. The apparatus according to claim 40, wherein the variable frequency signal comprises a square wave.

42. The apparatus according to claim 40, wherein the variable frequency signal comprises a sinusoidal wave.

43. A method for controlling an intensity of a light emitting diode (LED), the method comprising:
providing a housing having at least one light emitting unit, the at least one light emitting unit having at least one LED;
generating a variable frequency signal;
passing the variable frequency signal through a filter having a variable gain as a function of frequency, the filter having an output in communication with the at least one LED; and
varying a frequency of the variable frequency signal such that at least one component of the variable frequency signal is attenuated by the variable gain so as to modify the amount of electrical power delivered to the at least one LED.

44. An apparatus for controlling an light intensity of a light emitting diode (LED), the apparatus comprising:
a housing;
at least one light emitting unit arranged within the housing and containing at least one LED;
a signal generator operable to generate a variable pulse density signal;
a multivibrator in communication with the square wave generator and the at least one LED, the multivibrator generating a pulse of set duration each time a clock edge is detected on the variable pulse density signal; and
control logic in communication with the signal generator for controlling a pulse density of the variable pulse density signal, whereby the intensity of the at least one LED is varied by changing the pulse density of the variable pulse density signal.

45. A method for controlling an intensity of a light emitting diode (LED), the method comprising:
providing a housing having at least one light emitting unit arranged within the housing, the at least one light emitting unit containing at least one LED;
generating a variable pulse density signal;
generating drive signal comprising a pulse of fixed duration based on at least one edge of each pulse in the variable pulse density signal;
supplying the drive signal to the at least one LED; and
varying a pulse density of the variable pulse density signal so as to modify an amount of electrical power delivered to the at least one LED.

46. An apparatus for controlling a light intensity of a light emitting diode (LED), the apparatus comprising:
a housing;
at least one light emitting unit arranged within the housing and containing at least one LED;
a pulse signal generator operable to generate a first variable pulse density signal;
a sample signal generator operable to generate a sample signal;
a flip-flop in communication with the pulse signal generator, the sample signal generator, and the at least one LED, the flip-flop generating a second variable pulse density signal for driving the at least one LED in response to the first variable pulse density signal and the sample signal; and
control logic in communication with the sample signal generator and the pulse signal generator for controlling the sample signal and a pulse density of the first variable pulse density signal, whereby the intensity of the at least one LED is varied by changing at least one of the sample signal and the density of the pulses of the first variable pulse density signal.

47. A method for controlling an intensity of a light emitting diode (LED), the method comprising:
providing a housing having at least one light emitting unit arranged therein, the at least one light emitting unit containing at least one LED;
generating a first variable pulse density signal;
generating a sample signal;
supplying the first variable pulse density signal and the sample signal to a flip-flop, the flip-flop generating a second variable pulse density signal, the flip-flop having an output in communication with the at least one LED; and
varying a pulse density of the first variable pulse density signal so as to modify an amount of electrical power delivered to the at least one LED.

48. An apparatus for controlling an intensity of a light emitting diode (LED), the apparatus comprising:
a housing;
at least one light emitting unit arranged within the housing and containing at least one LED;
a signal generator in communication with the at least one LED and operable to generate a variable pulse density signal; and
control logic in communication with the signal generator for controlling a pulse density of the variable pulse density signal, whereby the intensity of the at least one LED is varied by changing the pulse density of the variable pulse density signal.

49. A method for controlling an intensity of a light emitting diode (LED), the method comprising:
providing a housing having at least one light emitting unit arranged within the housing, the at least one light emitting unit containing at least one LED;
generating a variable pulse density signal;
supplying the variable pulse density signal to the at least one LED; and
varying a pulse density of the variable pulse density signal so as to modify an amount of electrical power delivered to the at least one LED.

50. An apparatus for controlling an intensity of a plurality of light emitting diodes (LEDs), the apparatus comprising:
a housing;
at least one light emitting unit arranged within the housing, the at least one light emitting unit containing the plurality of LEDs;
a signal generator operable to generate a signal having a continuously variable voltage;
a digital number generator operable to generate a digital signal;
a decoder arranged to receive the digital signal from the digital number generator; and
a plurality of sample-and-hold circuits, each sample-and-hold circuit in communication with the signal generator, the decoder, and at least one of the plurality of LEDs, whereby the intensity of a different subset of the plurality of LEDs is varied by changing the continuously variable voltage based on output from the decoder.

51. The apparatus according to claim 50, wherein the apparatus implements a multiplexed analog control to control the intensity of the at least one LED.

52. A method for controlling an intensity of a light emitting diode (LED), the method comprising:
providing a housing having at least one light emitting unit arranged within the housing, the at least one light emitting unit containing at least one LED;
generating an analog control signal;
generating a digital signal;
generating at least one sample signal from the digital signal;
supplying the analog control signal and the at least one sample signal to a sample-and-hold circuit, the sample-and-hold circuit generating a second analog control signal, the sample-and-hold circuit having an output in communication with the at least one LED; and
varying the analog control signal so as to modify an amount of electrical power delivered to the at least one LED.

53. An apparatus for controlling an intensity of a light emitting diode (LED), the apparatus comprising:
a housing;
at least one light emitting unit arranged within the housing, the at least one light emitting unit containing at least one light emitting diode (LED);
a PWM signal generator operable to generate a first pulse width modulated (PWM) signal;
a sample signal generator operable to generate a sample signal;
a flip-flop in communication with the PWM signal generator, the sample signal generator, and the at least one LED, the flip-flop generating a second PWM signal for driving the at least on LED in response to the first PWM signal and the sample signal; and
control logic in communication with the sample signal generator and the PWM signal generator for controlling the sample signal and a duty cycle of pulses of the first PWM signal, whereby the intensity of the at least one LED may be varied.

54. A method for controlling an intensity of a light emitting diode (LED), the method comprising:
generating a first pulse width modulated (PWM) signal;
generating a sample signal;
supplying the first PWM signal and the sample signal to a storage device, the storage device generating a second PWM signal; and
driving the at least one LED with a signal based on the second PWM signal;
whereby varying at least one of the first PWM signal and the sample signal modifies an amount of electrical power delivered to the at least one LED.
